(19) United States
(12) Patent Application Publication
(10) Pub. No.: US 2023/0345949 A1
(43) Pub. Date: Nov. 2, 2023

(54) INSTANT COOKIE MAKER AND METHODS

(71) Applicant: Robert T. Williams, New Port Richey, FL (US)

(72) Inventor: Robert T. Williams, New Port Richey, FL (US)

(21) Appl. No.: 18/128,896

(22) Filed: Mar. 30, 2023

Related U.S. Application Data
(60) Provisional application No. 63/326,441, filed on Apr. 1, 2022.

(51) Int. Cl. A21B 3/15; A21B 3/00; A21B 1/02

(52) U.S. Cl. CPC A21B 1/02; A21B 3/006; A21B 3/15

(57) ABSTRACT

The present application discloses an instant cookie maker, configured to make one single hot and fresh cookie in a short period of time, e.g., 3 minutes or less. Methods of fabricating and using the same are also disclosed.

### CROSS-REFERENCE TO RELATED APPLICATION

This application claims the benefit U.S. Provisional Application No. 63/326,441, filed Apr. 1, 2022, the teaching of which is incorporated herein by reference in its entirety.

### FIELD OF THE INVENTION

The present invention relates to an instant cookie maker and methods of making and use thereof.

### BACKGROUND OF THE INVENTION

When one craves a fresh hot cookie, the only current practical way to accomplish this is to bake a full batch (usually 2 dozen or so) and only the first ones are the delicious hot and chewy type. The rest get cold and are not as appetizing. Including the pre-heating time of the oven, this process can take 30 minutes or more. Prolonged craving would magnify such craving, and availability of cookies would make it hard to control calorie intake.

The embodiments provided below address the above identified issues and needs.

### SUMMARY OF THE INVENTION

In one aspect of the present invention, it is provided an instant cookie maker, configured to make one single hot and fresh cookie in a short period of time, e.g., 5 minutes or 3 minutes or less.

In some embodiments of the disclosed cookie maker, optionally in combination with any of the embodiments disclosed herein, the instant cookie maker is configured to make one single hot and fresh cookie in 5 minutes or less by baking dough of a cookie, the cookie maker comprising:
an enclosed cookie chamber (1) with and LED light (2) and a window (3) for viewing the status of the baking, the cookie chamber having a dimension that is sufficient for housing a Teflon coated tray (4) to place a cookie dough on, configured to slide in and out through a slot (5) and is easy to clean,
a heat generating device (6),
a circulating fan (7) for even distribution of heat,
a dial (8) for selecting a duration of baking,
a power source (10), and
a rear door (9) for cleaning crumbs from the cookie chamber.

In some embodiments of the disclosed cookie maker, optionally in combination with any of the embodiments disclosed herein, the instant cookie maker is configured to allow a user to select a duration of baking from 30 seconds to 3 minutes.

In some embodiments of the disclosed cookie maker, optionally in combination with any of the embodiments disclosed herein, the heat generating device comprises an electric heater.

In some embodiments of the disclosed cookie maker, optionally in combination with any of the embodiments disclosed herein, the dial comprises a touch screen (8a).

In some embodiments of the disclosed cookie maker, optionally in combination with any of the embodiments disclosed herein, the touch screen is configured to display a calorie count of the cookie.

In some embodiments of the disclosed cookie maker, optionally in combination with any of the embodiments disclosed herein, the calorie count is a sum of cookies made and baked by the instant cookie maker in a day.

In some embodiments of the disclosed cookie maker, optionally in combination with any of the embodiments disclosed herein, wherein the touch screen is configured to display a calorie count of the cookie.

In some embodiments of the disclosed cookie maker, optionally in combination with any of the embodiments disclosed herein, having a dimension of height-width-depth of up to 8 inches × 8 inches × 8 inches.

In some embodiments of the disclosed cookie maker, optionally in combination with any of the embodiments disclosed herein, wherein the power source is a battery.

In another aspect of the present invention, it is provided a method of fabricating an instant cookie maker, the cookie maker being configured to make one single hot and fresh cookie in a short period of time, e.g., 5 minutes or 3 minutes or less.

In some embodiments of the disclosed method, optionally in combination with any of the embodiments disclosed herein, optionally in combination with any of the embodiments disclosed herein, the instant cookie mater comprises:
an enclosed cookie chamber with and LED light and a window for viewing the status of the baking, the cookie chamber having a dimension that is sufficient for housing a Teflon coated tray to place a cookie dough on, configured to slide in and out through a slot and is easy to clean,
an electric heating element,
a circulating fan for even distribution of heat,
a dial for selecting a duration of baking,
a power source, and
a rear door for cleaning crumbs from the cookie chamber.

In some embodiments of the disclosed method, optionally in combination with any of the embodiments disclosed herein, optionally in combination with any of the embodiments disclosed herein, the dial is configured to allow a user to select a duration of baking from 30 seconds to 3 minutes.

In some embodiments of the disclosed method, optionally in combination with any of the embodiments disclosed herein, optionally in combination with any of the embodiments disclosed herein, the heat generating device comprises an electric heater.

In some embodiments of the disclosed method, optionally in combination with any of the embodiments disclosed herein, optionally in combination with any of the embodiments disclosed herein, the dial comprises a touch screen.

In some embodiments of the disclosed method, optionally in combination with any of the embodiments disclosed herein, optionally in combination with any of the embodiments disclosed herein, the touch screen is configured to display a calorie count of the cookie.

In some embodiments of the disclosed method, optionally in combination with any of the embodiments disclosed herein, optionally in combination with any of the embodiments disclosed herein, the calorie count is a sum of cookies made and baked by the instant cookie maker in a day.

### BRIEF DESCRIPTION OF THE DRAWINGS

FIGS. 1, 2, 5 and 6 show embodiments of the disclosed instant cookie maker.

FIGS. 3 and 4 show dimensions of an embodiment of the disclosed instant cookie maker in height, width, and depth.

### DETAILED DESCRIPTION OF THE INVENTION

### Definitions

As used herein, the term “hot and fresh” refers to a state/condition of a food article freshly cooked or baked. For example, being hot and fresh can be a state being cooked immediately before or within 10 minutes or 5 minutes of consumption.

As used herein, the term “small” refers to a dimension of inches and is generally less than a foot, e.g., less than 10 inches, less than 8 inches, or less than 6 inches. In some embodiments, the dimension can be of from about 3 inches to 5 inches, about 3 inches to 6 inches, or about 3 inches to 8 inches, or about 3 inches to 10 inches.

As used herein, the term calorie count refers to the total calorie count of one or more cookies made by the disclosed cookie maker. Alternatively, the term calorie count can be shown by the number of cookie or cookies made by the disclosed cookie maker.

### Instant Cookie Maker

In one aspect of the present invention, it is provided a configured to make one single hot and fresh cookie in a short period of time, e.g., 3 minutes or less. Using a small chamber and concentrated circulating heat, the invention quickly brings the cookie dough up to the desired baking temperature levels. Also, by baking only one cookie at a time, there are no undesirable cold leftover cookies.

As such, the disclosed cookie maker would work well for those living alone, office break rooms, and those just simply desiring a single hot fresh-baked cookie. Additionally, my invention is configured to make available a single cookie within a relatively short period of time, e.g., a few minutes (less than 3 minutes, for example).

In some embodiments of the disclosed cookie maker, optionally in combination with any of the embodiments disclosed herein, the instant cookie maker comprises:
an enclosed cookie chamber with and LED light and a window for viewing the status of the baking, the cookie chamber having a dimension that is sufficient for housing a Teflon coated tray to place a cookie dough on, configured to slide in and out through a slot and is easy to clean,
an electric heating element,
a circulating fan for even distribution of heat,
a dial for selecting, e.g., the temperature and/or heating time,
a power source that can be 110 volts, 220 volts or 240 volts or battery, and
a rear door for cleaning crumbs from the cookie chamber.

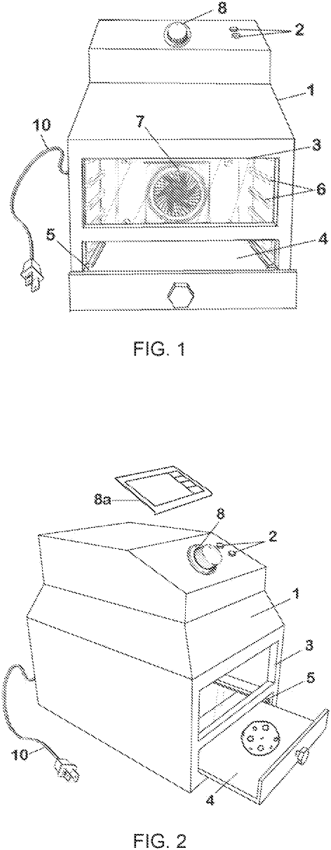

FIGS. 1-6 show various embodiments of the disclosed instant cookie maker. FIG. 1 and FIG. 6 show front views of an embodiment of the disclosed instant cookie maker while FIGS. 2-5 show various side views of an embodiment of the disclosed instant cookie maker. In FIG. 1 and FIG. 6, an embodiment of the disclosed instant cookie maker is shown to include an enclosed cookie chamber (1) with and LED light (2) and a window (3) for viewing the status of the baking, the cookie chamber having a dimension that is sufficient for housing a Teflon coated tray (4) to place a cookie dough on, configured to slide in and out through a slot (5) and is easy to clean, a heat generating device (6), a circulating fan (7) for even distribution of heat, a dial (8) for selecting a duration of baking, a power source (10), and a rear door (9) for cleaning crumbs from the cookie chamber.

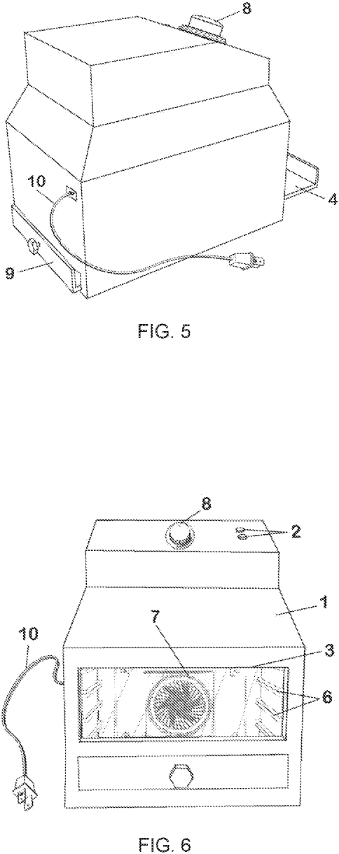

Referring to FIG. 1, again and FIGS. 2 and 5, an embodiment of the present disclosure has an enclosed cookie chamber (1) with and LED light (2) and a window (3) for viewing the status of the baking, the cookie chamber having a dimension that is sufficient for housing a Teflon coated tray (4) to place a cookie dough on, configured to slide in and out through a slot (5) and is easy to clean, a heat generating device (6), a circulating fan (7) for even distribution of heat, a dial (8) for selecting a duration of baking, a power source (10), and a rear door (9) (FIG. 5) for cleaning crumbs from the cookie chamber.

Further, in FIG. 2, it is shown that a dial (8) can be replaced by a touch screen 8a.

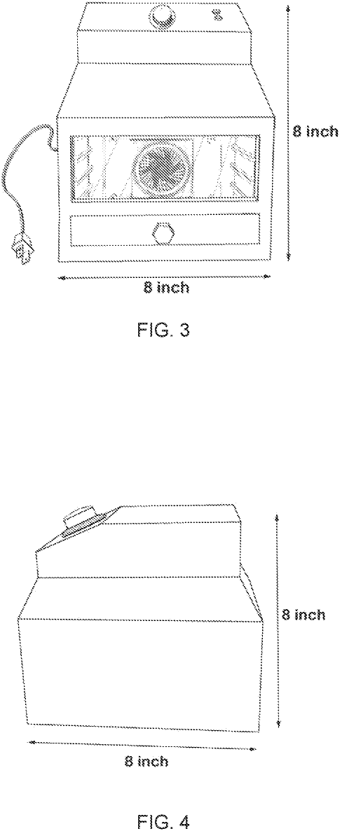

FIGS. 3 and 4 show dimensions of an embodiment of the disclosed instant cookie maker as being 8 inches in height, width, and depth.

In some embodiments, the disclosed instant cookie maker has a width-height-depth dimension of 8 up to inches × 8 inches × 8 inches. Such a size would save space, which is an important factor of urban living, and allow a user to set and use the instant cookie maker essentially everywhere he/she goes. In some embodiments, the instant cookie maker can be battery powered, and such battery can be disposal battery or rechargeable battery. As used herein, a dimension of height-width-depth of up to 8 inches × 8 inches × 8 inches shall mean any of height-width-depth dimensions stay 8 inches or below.

### Calorie Count

Calorie count in a cookie dough is usually provided by the maker of the dough. In case a user elects to make his own cookie dough, he/she can derive a calorie count of a dough by the mass or weight of each ingredient that is used to make a cookie dough. For example, if used, wheat flour has a per 100 grams calorie count of 364 calories, peanut butter a per 100 grams calorie count of 588 calories, sugar a per 100 grams calorie count of 387 calories, raisins a per 100 grams calorie count of 299 calories, dry almonds a per 100 grams calorie count of 827 calories, and oil a per 100 grams calorie count of 884 calories. It is noteworthy that each edible food article would have a published calorie count so that one can readily calculate the calorie count of a cookie dough.

### Method of Use

In one embodiment, a user (“User”) is instructed to slice about ¼″ thickness of cookie dough from a standard cookie dough tube. Place the dough on the Teflon coated tray and slide into the cookie chamber thought the slot in front. Turn dial to desired “doneness” of chewy to crispy. Heating element and circulating fan are powered up and the baking process begins quickly. Within a selected period (e.g., 3 minutes) the cookie will be done and the heating element and fan will power down (unit will “beep”). User then slides the Teflon tray from the chamber and allows cookie to cool slightly. Then, enjoys a hot fresh-baked cookie.

### Method of Fabrication

In another aspect of the present invention, it is provided a method of fabricating an instant cookie maker. The instant cookie mater includes an enclosed cookie chamber with and LED light and a window for viewing the status of the baking, the cookie chamber having a dimension that is sufficient for housing a Teflon coated tray to place a cookie dough on, configured to slide in and out through a slot and is easy to clean,
an electric heating element,
a circulating fan for even distribution of heat,
a dial for selecting,
a power source that can be 110 volts, 220 volts or 240 volts or battery, and
a rear door for cleaning crumbs from the cookie chamber.

Using the combination of a small cooking chamber and concentrated circulated heat, this invention allows the cookie to quickly reach desired baking temperature.

Cookie maker would be manufactured as described above. User would supply cookie dough.

In some embodiments, an optional design can be made to use induction heat under the cooking surface and convection on top. This induction heat can speed up the cooking process. For example, a user can simply plug into a power (e.g., 110 V) source, insert the user provided cookie dough and start the machine.

The instant cookie maker can be used to quickly cook small individual pizzas, fried eggs, candy, etc. A user can readily adjust the temperature and duration of heating to make any of such particular food article.

A person of ordinary skill in the art can readily assemble an instant cookie maker according to the disclosure herewith.

FIGS. 1-6 show various front and side views of an embodiment of the disclosed instant cookie maker.

### EXAMPLES

The following examples are provided to illustrate, and not meant to limit, the scope of the invention disclosed herein.

FIGS. 1A-1F show various front and side views of an embodiment of the disclosed instant cookie maker.

It is understood that the foregoing detailed description and the following examples are illustrative only and are not to be taken as limitations upon the scope of the invention. Various changes and modifications to the disclosed embodiments, which will be apparent to those of skill in the art, may be made without departing from the spirit and scope of the present.

Those skilled in the art will know, or be able to ascertain, using no more than routine experimentation, many equivalents to the specific embodiments of the invention described herein. These and all other equivalents are intended to be encompassed by the following claims.

I claim:

1. An instant cookie maker, configured to make one single hot and fresh cookie in 5 minutes or less by baking dough of a cookie, the cookie maker comprising:
an enclosed cookie chamber with and LED light and a window for viewing the status of the baking, the cookie chamber having a dimension that is sufficient for housing a Teflon coated tray to place a cookie dough on, configured to slide in and out through a slot and is easy to clean,
a heat generating device,
a circulating fan for even distribution of heat,
a dial for selecting a duration of baking,
a power source, and
a rear door for cleaning crumbs from the cookie chamber.

2. The instant cookie maker of claim 1, wherein the dial is configured to allow a user to select a duration of baking from 30 seconds to 3 minutes.

3. The instant cookie maker of claim 1, wherein the heat generating device comprises an electric heater.

4. The instant cookie maker according to claim 1, wherein the dial comprises a touch screen.

5. The instant cookie maker according to claim 4, wherein the touch screen is configured to display a calorie count of the cookie.

6. The instant cookie maker according to claim 1, having a dimension of height-width-depth of up to 8 inches x 8 inches x 8 inches.

7. The instant cookie maker according to claim 1, wherein the power source is a battery.

8. The instant cookie maker according to claim 7, wherein the battery is a rechargeable battery.

9. A method of fabrication, comprising providing a design of an instant cookie maker and forming the instant cookie mater, the instant cookie mater comprising:
an enclosed cookie chamber with and LED light and a window for viewing the status of the baking, the cookie chamber having a dimension that is sufficient for housing a Teflon coated tray to place a cookie dough on, configured to slide in and out through a slot and is easy to clean,
an electric heating element,
a circulating fan for even distribution of heat,
a dial for selecting a duration of baking,
a power source, and
a rear door for cleaning crumbs from the cookie chamber.

10. The method according to claim 9, wherein the dial is configured to allow a user to select a duration of baking from 30 seconds to 3 minutes.

11. The method according to claim 9, wherein the heat generating device comprises an electric heater.

12. The method according to claim 9, wherein the dial comprises a touch screen.

13. The method according to claim 11, wherein the touch screen is configured to display a calorie count of the cookie.

14. The method according to claim 9, having a dimension of height-width-depth of up to 8 inches × 8 inches × 8 inches.

15. The method according to claim 9, wherein the power source is a battery.

16. The method according to claim 15, wherein the battery is a rechargeable battery.
